(19) United States
(12) Patent Application Publication
(10) Pub. No.: US 2017/0291469 A1
(43) Pub. Date: Oct. 12, 2017

(54) ELECTRONIC VENTILATION REGISTER CONTROL SYSTEM FOR A MOTOR VEHICLE

(71) Applicant: FORD GLOBAL TECHNOLOGIES, LLC, Dearborn, MI (US)

(72) Inventors: Adrian Romero Regalado, Cuautitlan Izcalli (MX); Mario Oscar Martinez Ordaz, Mexico City (MX); Luis Francisco Guizar Amador, Guanajuato (MX); Diana Lucía Velásquez Lenis, Mexico City (MX)

(21) Appl. No.: 15/094,152

(22) Filed: Apr. 8, 2016

(51) Int. Cl. B60H 1/00; B60R 16/037; B60H 1/34

(52) U.S. Cl. CPC B60H 1/00871; B60H 1/3421; B60H 1/00985; B60R 16/0373; B60H 2001/3471

(57) ABSTRACT

A ventilation register control system is provided for a motor vehicle. That ventilation register control system includes four ventilation registers and a control module configured to independently open and close each ventilation register.

### TECHNICAL FIELD

This document relates generally to the motor vehicle equipment field and, more particularly, to an electronic ventilation register control system incorporating a voice actuator, mechanical actuator or electronic actuator for independently opening and closing the airflow control elements or ventilation vanes associated with each of a plurality of the ventilation registers. Such a system allows a single individual, such as the driver, to conveniently control the flow of air through all of the ventilation registers into the passenger cabin of the motor vehicle.

### BACKGROUND

Motor vehicles today are equipped with numerous ventilation registers for distributing air throughout the passenger cabin of the motor vehicle and, more particularly, toward the various occupant seating positions in the motor vehicle. Significantly, a motor vehicle is not always occupied by the same number of passengers and it is necessary to adjust air flow through the various ventilation registers in order to optimize HVAC efficiency and the comfort of the motor vehicle occupants. For example, there are occasions when just the driver occupies the motor vehicle. In a situation where that driver wishes to focus airflow from the HVAC system exclusively upon himself, it was necessary in the past to manually close the other ventilation registers of the motor vehicle. It is, of course, inconvenient and, at least in wider vehicles, difficult to reach across the motor vehicle from the driver's seat to an air register adjacent the passenger door in order to close that air register.

This document relates to a new and improved ventilation register control system incorporating a single actuator for independently opening and closing the various airflow control elements or sets of ventilation vanes provided in the various ventilation registers throughout the motor vehicle. That actuator is adapted to be easily used in a convenient and efficient manner by the driver. That is true whether the actuator is a voice actuator, a mechanical actuator or an electronic actuator. As such, the ventilation register control system set forth in this document allows for more convenient and effective control of the ventilation system for the benefit of the driver and represents a significant advance in the art.

### SUMMARY

In accordance with the purposes and benefits described herein, a ventilation register control system is provided for a motor vehicle. That ventilation register control system includes a plurality of ventilation registers that are located at various locations in the passenger cabin of the motor vehicle in order to distribute air throughout the passenger cabin and toward various passenger seating locations. The ventilation register control system also includes a plurality of ventilation vanes, one set of ventilation vanes for each ventilation register. Additionally, the ventilation register control system includes a control module that is configured to allow independent opening and closing of each set of ventilation vanes. That control module may also include a single actuator for independently opening and closing the sets of ventilation vanes associated with the plurality of ventilation registers. Thus, the ventilation register control system allows an operator, such as the driver, to conveniently and efficiently control the flow of air through the various ventilation registers to deliver that air to the cabin of the motor vehicle in any desired manner.

The control module may further include a plurality of ventilation vane drivers. One ventilation vane driver is connected to each set of ventilation vanes. Further, the control module includes a controller. In one possible embodiment, the control module also includes a voice processor and the controller is configured to be voice activated. In another possible embodiment, the control module includes a touch screen display and the controller is activated by the touch screen display. In yet another possible embodiment, the control module includes a single actuator for independently opening and closing sets of ventilation vanes. That single actuator may comprise a mechanical actuator including (a) a plurality of selectors, one selector for each set of ventilation vanes, and (b) a single switch for opening and closing a selected set of ventilation vanes of an individually selected ventilation register.

In accordance with an additional aspect, a ventilation register control system for a motor vehicle comprises: a first ventilation register, a second ventilation register and a control module configured to independently open or close the first ventilation register and the second ventilation register. That control module may include a controller connected to a first driver connected to a first air flow control element for the first ventilation register and a second driver connected to a second air flow control element for a second ventilation register.

The control module may include a voice processor with the controller configured to be voice activated. In another possible embodiment the control module includes a touch screen display for activating the system. In yet another possible embodiment, the control module includes a single actuator for independently opening and closing the first ventilation register and the second ventilation register.

Still further, the ventilation register control system may further include a third ventilation register and the control module may be further configured to independently open and close that third ventilation register. Still further, the ventilation register control system may further include a fourth ventilation register wherein the control module is further configured to independently open and close the fourth ventilation register.

In accordance with yet another aspect, a method is provided of controlling airflow through a ventilation system of a motor vehicle including multiple ventilation registers. That method comprises the step of independently opening and closing the multiple ventilation registers by means of a single actuator. Further, that method includes using an actuator selected from a group consisting of a voice actuator, a mechanical actuator and an electronic actuator. Such a mechanical actuator may include (a) a plurality of selectors, one selector for each set of ventilation vanes and (b) a single switch for opening or closing a selected set of ventilation vanes.

In the following description, there are shown and described several preferred embodiments of the ventilation register control system. As it should be realized, the ventilation register control system is capable of other, different embodiments and its several details are capable of modification in various, obvious aspects all without departing from the ventilation register control system as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the ventilation register control system and together with the description serve to explain certain principles thereof. In the drawing figures:

FIG. 1 is an interior view of the dashboard and instrument panel in a passenger cabin of the motor vehicle wherein that dashboard and instrument panel is equipped with four separate ventilation registers.

FIG. 2 is a schematic block diagram of a first embodiment of the ventilation register control system for the motor vehicle illustrated in FIG. 1.

FIG. 2a is a detailed perspective view of a mechanical actuator for the control module of the ventilation register control system illustrated in FIG. 2.

FIG. 3 is a block diagram of an alternative embodiment of the ventilation register control system incorporating a touch screen display in place of the actuator of the embodiment illustrated in FIG. 2.

FIG. 3a is a front view of the touch screen display illustrating how one may utilize the touch screen display to control the ventilation register control system.

FIG. 4 is a schematic block diagram of yet another embodiment of the ventilation register control system wherein the actuator of the FIG. 2 embodiment is replaced with a voice processor.

FIG. 4a is an illustration of the instrument panel demonstrating how the status of the ventilation registers may be displayed between a tachometer and speedometer of the motor vehicle.

Reference will now be made in detail to the present preferred embodiments of the ventilation register control system, examples of which are illustrated in the accompanying drawing figures.

### DETAILED DESCRIPTION

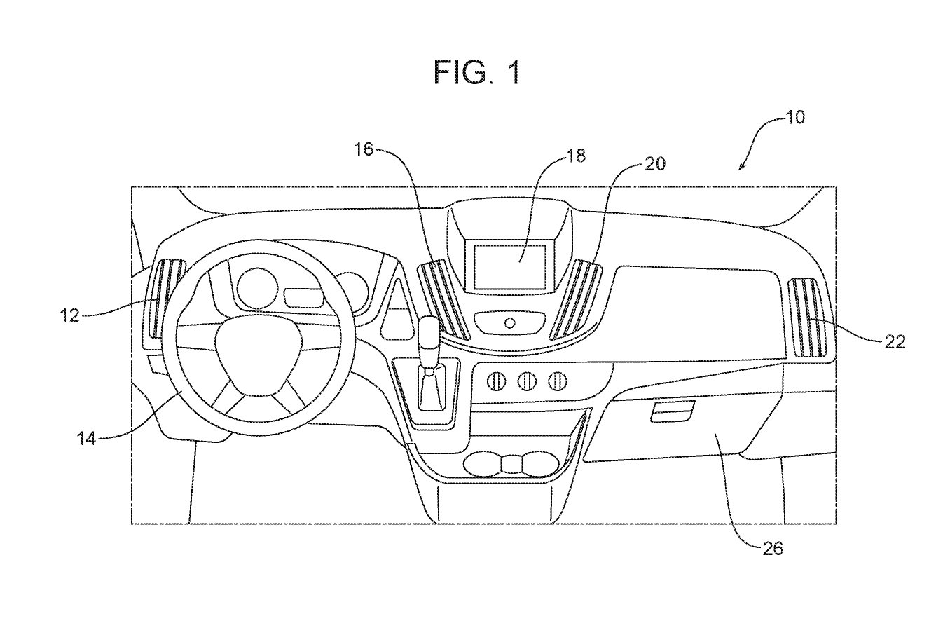

Reference is now made to FIG. 1 illustrating a dashboard 10 in the passenger cabin of the motor vehicle. That dashboard 10 includes a first ventilation register 12 to the left of the steering wheel 14, a second ventilation register 16 between the steering wheel and the central display 18, a third ventilation register 20 just to the right of the central display and a fourth ventilation register 22 at the far right of the dashboard adjacent the passenger door.

As should be appreciated, the driver of the motor vehicle seated behind the steering wheel 14 may use the first ventilation register 12 and second ventilation register 16 to direct the flow of air from the HVAC system onto his person while a passenger, seated behind the glovebox 26 in the passenger seat may adjust the third and fourth ventilation registers 20, 22 to direct air upon his person.

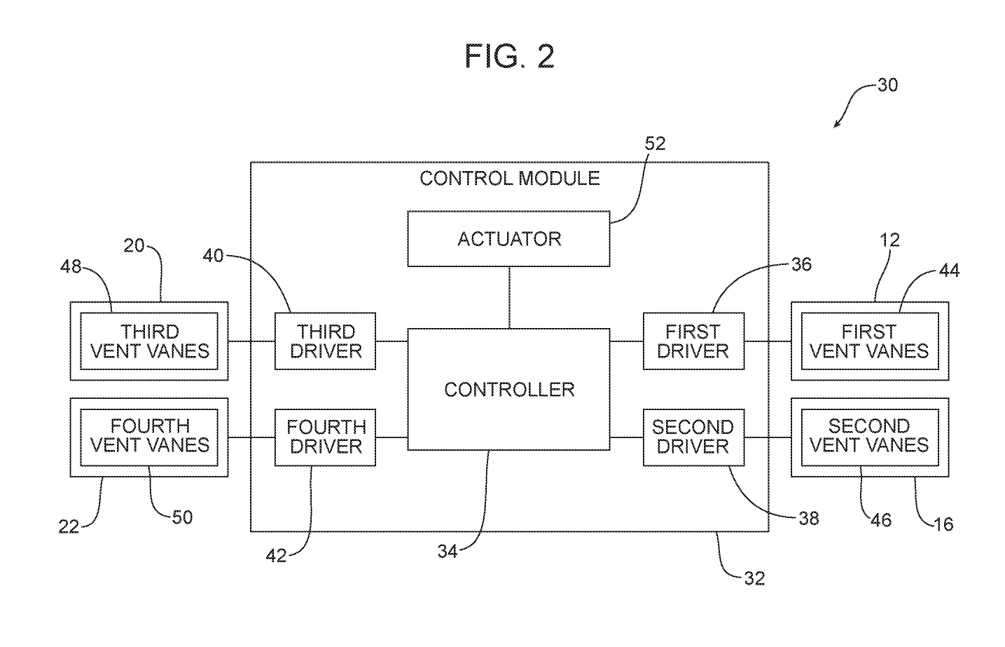

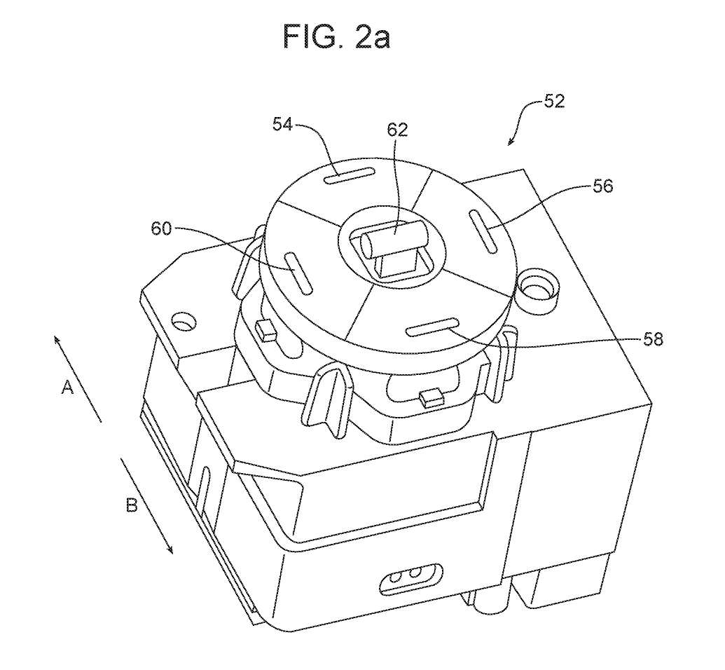

Reference is now made to FIG. 2 illustrating a first embodiment of the ventilation register control system 30. As illustrated, that ventilation register control system 30 includes the first, second, third and fourth ventilation registers 12, 16, 20, 22 and a control module 32. As will be appreciated from the following description, that control module 32 is configured to allow independent opening and closing of each of the ventilation registers 12, 16, 20, 22.

More specifically, the control module 32 includes a controller 34. The controller 34 is a computing device which may take the form of a dedicated microprocessor, an electronic control unit (ECU) operating in accordance with instructions from appropriate control software or like device. Thus, the controller 34 may comprise one or more processors, one or more memories and one or more network interfaces, which communicate over a communication bus.

In some embodiments, the controller 34 may be connected via a communication bus to a body control module (not shown). Such a body control module (BCM) may comprise a computing device having one or more processors, one or more memories and one or more network interfaces, a human interface, a GPS/geolocator component, a display device such as a multifunction display with touch screen capability and a speech processor that all communicate with each other over a communication bus. As is known in the art such a BCM performs a number of interior body electrically based functions including, for example, interior locking, remote key entry, interior lighting, exterior lighting, windshield wiper control and the like. In some embodiments, the BCM may also function to control entertainment functions (e.g. radio, CD player and communications such as telephone and internet communications over a wireless network). In some embodiments, the BCM is connected by a communication bus to other control modules that provide one or more of these additional functions.

As further illustrated in FIG. 2, the control module 32 also includes a first driver 36, a second driver 38, a third driver 40 and a fourth driver 42, all connected to and operated by the controller 34. In the illustrated embodiment, the first driver 36 is connected to a first airflow control element or set of vent vanes 44 for controlling the flow of air through the first ventilation register 12. The second driver 38 is connected to a second airflow control element or set of vent vanes 46 for controlling the flow of air through the second ventilation registers 16. The third driver 40 is connected to a third airflow control element or set of vent vanes 48 which control the flow of air through the third ventilation register 20. The fourth driver 42 is connected to a fourth airflow control element or set of vent vanes 50 which control the flow of air through the fourth ventilation register 22. As further illustrated in FIG. 2, the control module 32 also includes an actuator 52 which may be utilized by the motor vehicle operator to interface with the controller 34 in order to control the operation of the ventilation register control system 30.

As illustrated in FIG. 2a, the actuator 52 may take the form of a mechanical actuator. In the embodiment illustrated in FIG. 2a, that mechanical actuator 52 includes a plurality of selectors in the form of buttons 54, 56, 58 and 60. The operator pushes the first selector button 54 in order to select the first vent register 12, the second selector button 56 in order to select the second vent register 16, the third selector button 58 in order to select the third vent register 20 and the fourth selector button 60 in order to select the fourth vent register 22.

After selecting the desired vent register 12, 16, 20, or 22 by pushing the associated button 54, 56, 58 or 60, the operator engages the switch 62 located inside the four selector buttons 54, 56, 58, 60. If the operator pushes the switch 62 upward in the direction of action arrow A the set of vent vanes 44, 46, 48 or 50 associated with the selected ventilation register 12, 16, 20 or 22 are opened. In contrast, if the operator pushes the switch 62 downward in the direction of action arrow B, the set of vent vanes 44, 46, 48 or 50 associated with the selected ventilation register 12, 16, 20 or 22 are closed. In this way, the mechanical actuator 52 illustrated FIG. 2a allows one to independently open and close the first, second, third and/or fourth ventilation registers 12, 16, 20, 22 as desired. Thus, when a driver is in the vehicle alone, he may utilize the ventilation register control system 30 to selectively close the third and fourth ventilation registers 20, 22 that may be utilized to direct air toward the passenger so that more air will be directed from the HVAC system toward the driver via the first and second ventilation registers 12, 16 located to the left and right of the steering wheel 14.

In one possible embodiment, the actuator 52 is located on the dashboard 10 adjacent the first ventilation register 12 where it may be easily reached by the driver who can then conveniently and efficiently control the flow of air toward him for more efficient and effective heating and cooling on respected cold winter or hot summer days.

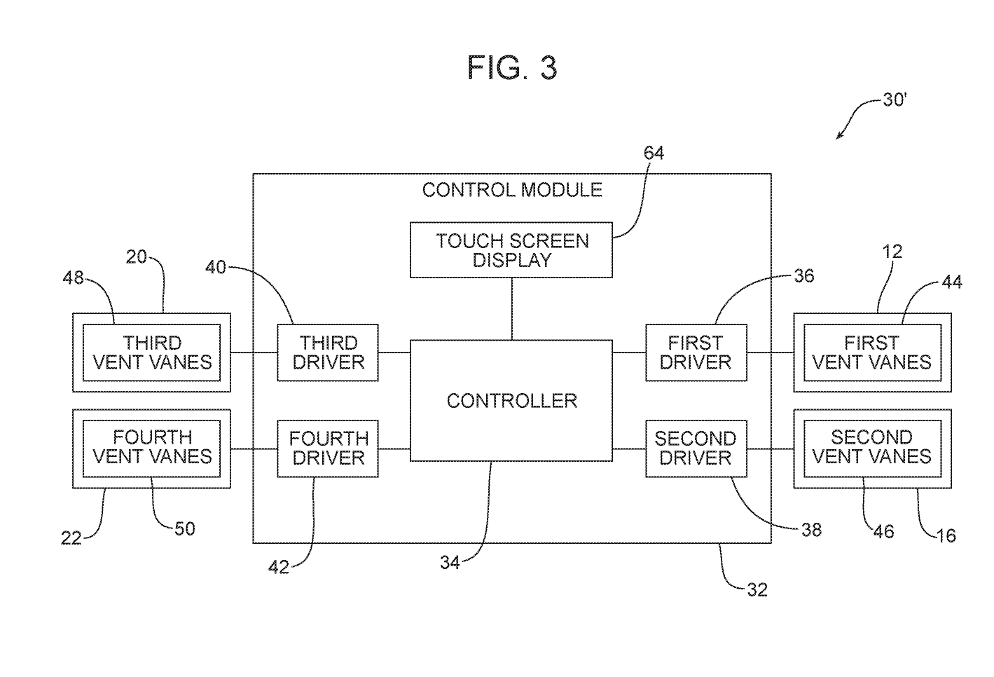

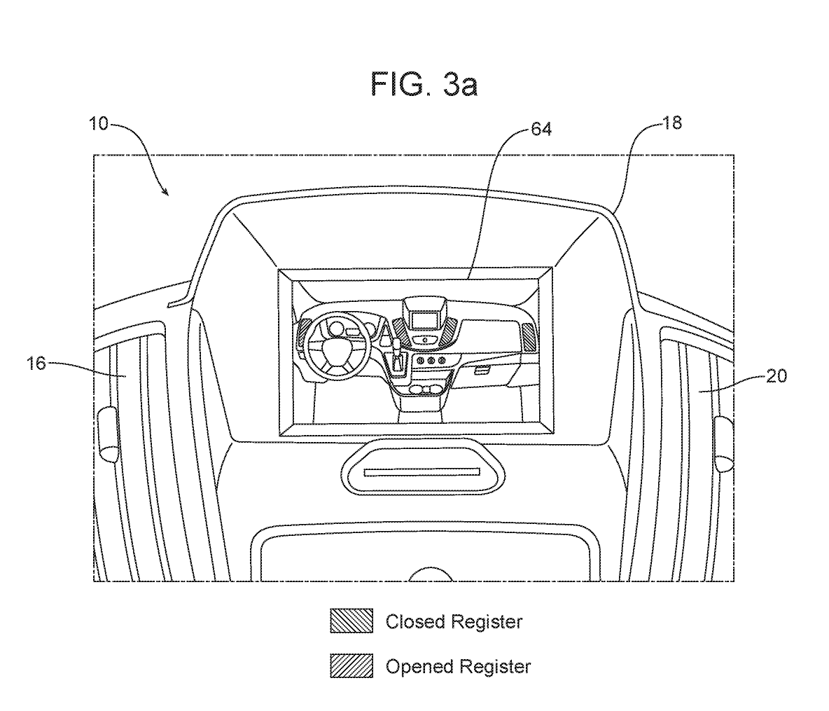

Reference is now made to FIG. 3 illustrating an alternative embodiment of the ventilation register control system 30′. The alternative embodiment of ventilation register control system 30′ is substantially identical to the first embodiment of the control system 30 illustrated in FIG. 2 except that a touch screen display 64 replaces the actuator 52. The other components of the second embodiment of the ventilation register control system 30′ are identified by identical reference numbers as for the first embodiment illustrated in FIG. 2 and function and operate in the same manner as described above.

As illustrated in FIG. 3a, the touch screen display 64 may be provided on the dashboard 10 at the top of the central display 18 where it is easily visible and easily reached by the driver. Advantageously, the touch screen display 64 functions as an electronic actuator for controlling the ventilation register control system 30′ when the system 30′ is activated. The touch screen display 64 shows a visual image of the dashboard 10 including the first, second, third and fourth ventilation registers 12, 16, 20, 22. If a ventilation register 12, 16, 20, 22 is currently opened, it may be displayed in a green color. If a ventilation register 12, 16, 20, 22 is currently closed it may be displayed in a red color. Thus, when the first and second ventilation registers 12, 16 are open, they are displayed in a green color and when the third and fourth ventilation registers 20, 22 are closed, they are displayed in a red color. If the operator touches the touch screen display 64 at a spot corresponding to the visual image of one of the ventilation registers, 12, 16, 20, 22, a signal is sent from the touch screen display 64 to the controller 34 which, in turn, sends an appropriate signal to the driver 36, 38, 40 or 42 of the selected register 12, 16, 20 or 22 to open that register if it was previously closed or to close that register if it was previously opened. Once the status of the selected register, 12, 16, 20 or 22 has been changed, the color in which that register 12, 16, 20, 22 is indicated on the touch screen display 64 is also changed to indicate its new opened/closed status.

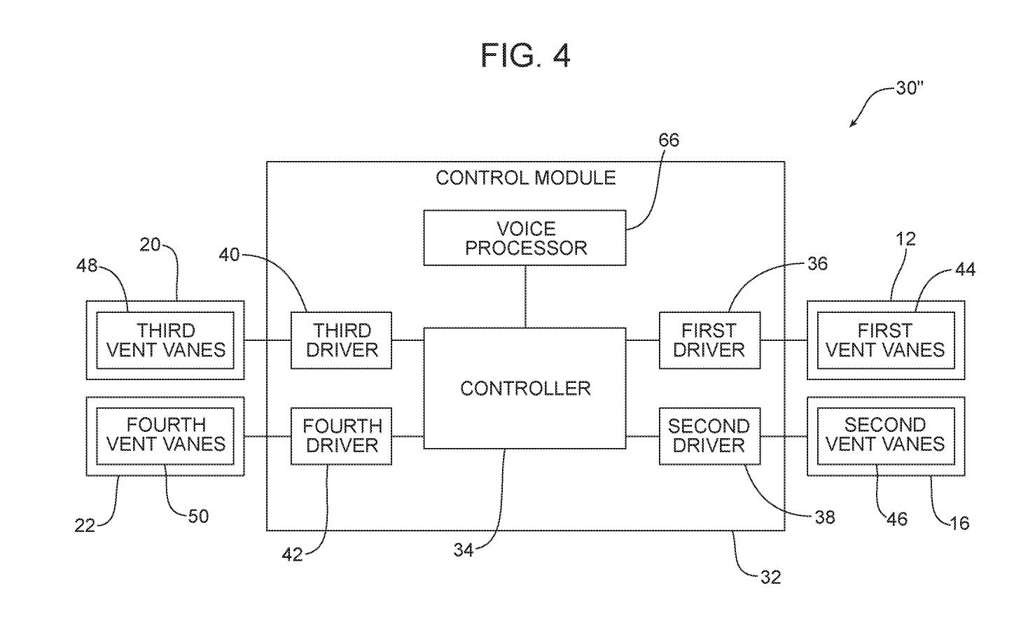

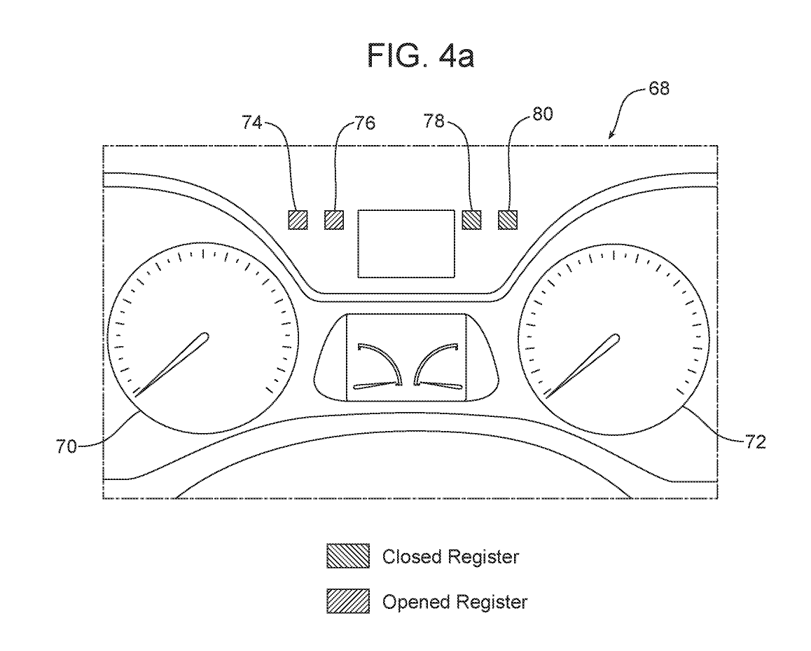

Reference is now made to FIG. 4 illustrating yet another embodiment of the ventilation register control system 30″. This third embodiment is very similar to the first embodiment 30 illustrated in FIG. 2 except that the actuator 52 has been replaced by a voice processor 66. The voice processor 66 may be a dedicated part of the control module 32 or it may be part of another control module such as a BCM connected to the control module 32.

In this embodiment, one controls the independent opening and closing of the ventilation registers 12, 16, 20 and 22 by voice command. Thus, for example, if the third ventilation register 20 is open and the operator wishes to close that register, he may state, “Close the third ventilation register.” The voice processor 66 recognizes this command and sends an appropriate signal to the controller 34 which, in turn, acts upon that signal by operating the third driver 40 to close the third set of vent vanes 48 of the third vent 20. Similar voice commands may be utilized to control the opening and closing of the other ventilation registers 12, 16, 22 as desired.

FIG. 4a illustrates another possible way of displaying the opened/closed status of the vent registers 12, 16, 20, 22 on the instrument panel 68 between the tachometer 70 and speedometer 72. In the illustrated embodiment, the first illuminated icon 74 indicates the opened/closed status of the first ventilation register 12, the second illuminated icon 76 indicates the opened/closed status of the ventilation register 16, the third illuminated icon 78 indicates the opened/closed status of the third ventilation register 20 and the fourth illuminated icon 80 indicates the opened/closed status of the fourth ventilation register 22. When the individual ventilation register 12, 16, 20 or 22 is opened, the icon 74, 76, 78, 80 may be illuminated in green. When the individual ventilation register 12, 16, 20, 22 is closed, the associated icon 74, 76, 78, 80 may be indicated in red.

Consistent with the above description, a method is provided for controlling airflow through a ventilation system of a motor vehicle including multiple ventilation registers 12, 16, 20, 22. That method may be broadly described as including the step of independently opening and closing the multiple ventilation registers by means of a single actuator 52, 64, 66. That actuator may be a mechanical actuator 52, a touch screen display 64 or a voice actuator 66. Any such actuator 52, 64 or 66 allows a driver to easily control the flow of air through all of the vent registers 12, 16, 20, 22 of the motor vehicle while sitting comfortably behind the steering wheel 14.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A ventilation register control system for a motor vehicle, comprising:
a plurality of ventilation registers;
a plurality of ventilation vanes, one set of ventilation vanes for each ventilation register; and
a control module configured to allow independent opening and closing of each said set of ventilation vanes.

2. The ventilation register control system of claim 1, wherein said control module includes a single actuator for independently opening and closing each said set of ventilation vanes.

3. The ventilation register control system of claim 2, wherein said actuator includes (a) a plurality of selectors, one selector for each said set of ventilation vanes and (b) a single switch for opening or closing a selected set of ventilation vanes.

4. The ventilation register control system of claim 2, wherein said actuator comprises a touch screen display.

5. The ventilation register control system of claim 1, wherein said control module is voice activated.

6. The ventilation register control system of claim 1, wherein said control module further includes a plurality of ventilation vane drivers, one ventilation vane driver being connected to each said set of ventilation vanes.

7. The ventilation register control system of claim 6, wherein said control module includes a controller.

8. The ventilation register control system of claim 7, wherein said control module includes a voice processor and said controller is configured to be voice activated.

9. The ventilation register control system of claim 7, wherein said control module includes a touch screen display for activating said controller.

10. The ventilation register control system of claim 7, wherein said control module includes a single actuator for independently opening and closing said each said set of ventilation vanes.

11. The ventilation register control system of claim 10, wherein said actuator includes (a) a plurality of selectors, one selector for each said set of ventilation vanes and (b) a single switch for opening or closing a select set of ventilation vanes.

12. A ventilation register control system for a motor vehicle, comprising:
a first ventilation register;
a second ventilation register; and
a control module configured to independently open or close said first ventilation register and said second ventilation register.

13. The ventilation register control system of claim 12, wherein said control module includes a controller connected to a first driver connected to a first airflow control element for said first ventilation register and a second driver connected to a second airflow control element for said second ventilation register.

14. The ventilation register control system of claim 13, wherein said control module includes a voice processor and said controller is configured to be voice activated.

15. The ventilation register control system of claim 12, wherein said control module includes a touch screen display for activating said system.

16. The ventilation register control system of claim 12, wherein said control module includes a single actuator for independently opening and closing said first ventilation register and said second ventilation register.

17. The ventilation register control system of claim 12, further including a third ventilation register wherein said control module is further configured to independently open and close said third ventilation register.

18. The ventilation register control system of claim 17, further including a fourth ventilation register wherein said control module is further configured to independently open and close said fourth ventilation register.

19. A method of controlling airflow through a ventilation system of a motor vehicle including multiple ventilation registers, comprising:
independently opening and closing said multiple ventilation registers by means of a single actuator.

20. The method of claim 19, further including using an actuator selected from a group consisting of a voice actuator, a mechanical actuator and/or electronic actuator.
